(19) United States
(12) Patent Application Publication
(10) Pub. No.: US 2017/0009905 A1
(43) Pub. Date: Jan. 12, 2017

(54) DEVICE FOR AUTOMATICALLY FILLING FRACKING PUMP FUEL TANKS

(71) Applicant: Arnold Oil Company of Austin, L.P., Austin, TX (US)

(72) Inventor: Jayson Arnold, Buda, TX (US)

(21) Appl. No.: 15/203,537

(22) Filed: Jul. 6, 2016

Related U.S. Application Data
(60) Provisional application No. 62/188,945, filed on Jul. 6, 2015.
(60) Provisional application No. 62/319,212, filed on Apr. 6, 2016.

(51) Int. Cl. F16K 31/26; F16K 21/18; B67D 7/36; E21B 43/26; B67D 7/04

(52) U.S. Cl. CPC F16K 31/26; E21B 43/26; B67D 7/04; B67D 7/365; F16K 21/18

(57) ABSTRACT

A system for automatically filling a fuel tank coupled to a fracking pump is described. The filling system includes a device that automatically opens and closes fuel flow to the fuel tank based on a level of fuel in the fuel tank. The device may close fuel flow to the fuel tank when a fill capacity of the fuel tank is reached. The device may open fuel flow to the fuel tank when a fuel level in the fuel tank drops below a selected level (e.g., below 1/4 of the fill capacity of the fuel tank). The device may be used to substantially continuously supply fuel to the fuel tank.

### PRIORITY CLAIM

This patent claims priority to U.S. Provisional Patent Application No. 62/188,945 to Arnold, entitled “DEVICE FOR AUTOMATICALLY FILLING FRACKING PUMP FUEL TANKS”, filed Jul. 6, 2015, and to U.S. Provisional Patent Application No. 62/319,212 to Arnold, entitled “DEVICE FOR AUTOMATICALLY FILLING FRACKING PUMP FUEL TANKS”, filed Apr. 6, 2016, both of which are incorporated by reference in its entirety as if fully set forth herein.

### BACKGROUND

1. Field of the Invention

The present invention relates to refueling systems for fracking pumps. More particularly, the invention relates to devices that provide automatic fueling fracking pump fuel tanks while the fracking pumps are in use.

2. Description of Related Art

Fuel tanks for fracking pumps are refilled while the fracking pumps are running so that the fracking process has little to no downtime. The fuel tanks are typically manually refueled so that the pumps can continuously run and maintain the fracking process. Manually refueling the fuel tanks while the fracking process is running, however, requires significant manpower hours to be able to keep the fracking pumps running continuously as any pump downtime can be detrimental or even catastrophic to the fracking process. Additionally, refueling the pumps while the fracking process is running may be dangerous to the refueling personnel as the fuel tanks are filled while machinery (e.g., pumps) are at elevated temperatures, in a high pressure environment, when flammable/explosive vapors are present, and/or in a high noise level environment.

### SUMMARY

In certain embodiments, an automatic filling device for a fuel tank coupled to a fracking pump includes a valve body configured to be coupled to a fuel cap connection on the fuel tank; a fuel supply port on an upper portion of the valve body; a fuel discharge opening on a lower portion of the valve body; a fuel chamber in the valve body connecting the fuel supply port and the fuel discharge opening to allow fuel to flow between the fuel supply port and the fuel discharge opening, wherein, when the valve body is coupled to the fuel tank, the fuel supply port is located outside the fuel tank and the fuel discharge opening is located inside the fuel tank; a main fuel plug located on the fuel chamber above the fuel discharge opening, wherein, when open, the main fuel plug allows fuel to flow in the fuel chamber towards the fuel discharge opening and, when closed, the main fuel plug inhibits fuel to flow towards the fuel discharge opening; a primary float located on the fuel chamber above the main fuel plug, wherein the primary float closes when a first selected fuel level is reached in the fuel tank; a pressure tube coupled between the main fuel plug and the primary float, wherein, when the primary float closes, the pressure tube is filled with back pressure and causes the main fuel plug to close; and a secondary float located on the fuel chamber above the main fuel plug, wherein the secondary float operates a mechanical seal located at a bottom of the pressure tube, and wherein the secondary float closes the mechanical seal when the secondary float is above the first selected fuel level and the secondary float opens the mechanical seal when the secondary float is below a second selected fuel level.

In some embodiments, the secondary float is positioned to reach the first selected fuel level before the primary float when the fuel tank is being filled with fuel such that the secondary float closes the mechanical seal before the primary float closes. In some embodiments, a plunger is located at the fuel discharge opening and the plunger opens under pressure when fuel flows towards the opening and closes when fuel flow towards the opening is stopped and pressure on the plunger is relieved. In some embodiments, a mesh screen is positioned at the fuel discharge opening. In some embodiments, a vent port is located outside the fuel tank when the valve body is coupled to the fuel tank. The vent line may be coupled to a vent line that opens to the fuel tank when the valve body is coupled to the fuel tank and the vent line and the vent port release pressure from the fuel tank while filling the fuel tank.

In some embodiments, the first selected fuel level is a fill capacity of the fuel tank. In some embodiments, the second selected fuel level is less than the first selected fuel level. In some embodiments, the second selected fuel level is at least about ¼ a capacity of the fuel tank.

In certain embodiments, a system for filling a fuel tank coupled to a fracking pump includes the device described herein. The device may be configured to automatically open and close fuel flow to a fuel tank coupled to a fracking pump. The device may automatically open and close fuel flow to the fuel tank based on a level of fuel in the fuel tank.

In certain embodiments, a method for filling a fuel tank coupled to a fracking pump includes providing fuel from a fuel source to the fuel tank coupled to the fracking pump. A flow of the fuel into the fuel tank may be automatically controlled by a device described herein coupled to a fuel cap connection on the fuel tank. The device may automatically open and close the flow of fuel to the fuel tank based on a level of fuel in the fuel tank.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a side-view representation of an embodiment of a fuel valve.

FIGS. 2, 2A, 2B, and 2C depict representations of another embodiment of a fuel valve in an open position.

FIGS. 3, 3A, 3B, and 3C depict representations of the embodiment of the fuel valve of FIG. 2 in a half-open position.

FIGS. 4, 4A, 4B, and 4C depict representations of the embodiment of the fuel valve of FIG. 2 in a closed position.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to. Additionally, as used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to”.

### DETAILED DESCRIPTION OF EMBODIMENTS

The following examples are included to demonstrate preferred embodiments. It should be appreciated by those of skill in the art that the techniques disclosed in the examples which follow represent techniques discovered by the inventor to function well in the practice of the disclosed embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosed embodiments.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

In the context of this patent, the term “coupled” means either a direct connection or an indirect connection (e.g., one or more intervening connections) between one or more objects or components. The phrase “directly connected” means a direct connection between objects or components such that the objects or components are connected directly to each other so that the objects or components operate in a “point of use” manner.

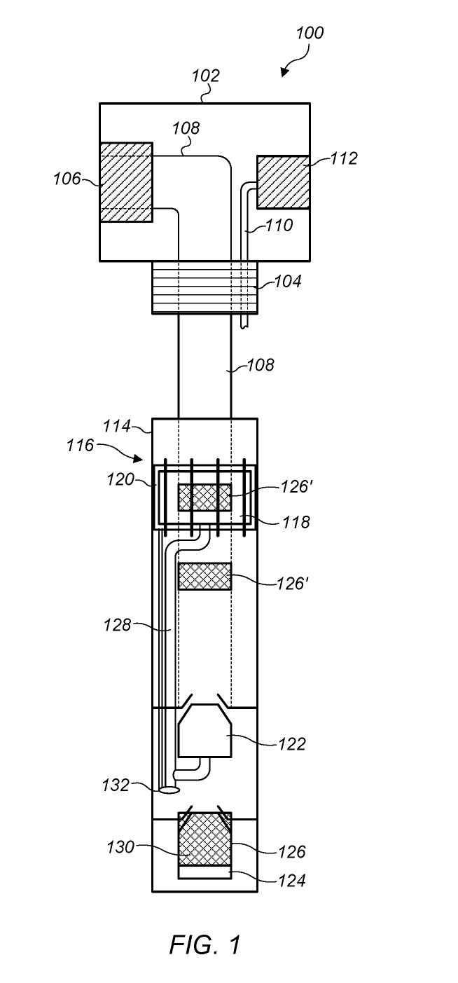

FIG. 1 depicts a side-view representation of an embodiment of fuel valve 100. Fuel valve 100 may be used on a fuel tank such as a fracking pump fuel tank. In certain embodiments, fuel is provided to fuel valve from a fuel source. The fuel source may be, for example, a fuel delivery system or any fuel system that stores and delivers fuel. The fuel source may include one or more fuel storage tanks. In certain embodiments, fuel valve 100 replaces the fuel cap on the fuel tank. Fuel valve 100 may include valve body 102. Valve body 102 may include threads 104. Threads 104 may match threads on the fuel cap connector of the fuel tank and be used to couple fuel valve 100 to the fuel tank (e.g., the fuel valve is screwed into the fuel cap connector on the fuel tank).

In certain embodiments, fuel valve 100 includes fuel supply port 106. Fuel supply port 106 may include threads to couple fuel valve 100 to a fuel line connector. As shown in FIG. 1, fuel supply port 106 may be coupled to fuel chamber 108. Fuel chamber 108 may provide a path for fuel to flow through fuel valve 100.

In certain embodiments, valve body 102 includes vent line 110 and vent port 112. Vent line 110 and vent port 112 may be used to release pressure during filling of the fuel tank from fuel valve 100. Vent port 112 may be coupled to a suitable vent system. In some embodiments, vent port 112 includes threads that couple to a vent system connector.

As shown in FIG. 1, fuel chamber 108 may continue down into lower body 114 of fuel valve 100 to supply fuel into the lower body of the fuel valve. In certain embodiments, fuel chamber 108 couples to valve system 116. In certain embodiments, valve system 116 includes primary float 118, secondary float 120, main fuel plug 122, plunger 124, mesh screen 126, and pressure tube 128.

When fuel flows through fuel chamber 108 into valve system 116, the pressure created by the flow of fuel may open main fuel plug 122 and plunger 124, as shown in FIG. 1. In certain embodiments, plunger 124 includes a light spring that allows the fuel flow to push the plunger down and fuel escapes into the fuel tank through opening 130 (e.g., a fuel discharge opening in fuel valve 100). When fuel flow is cutoff (e.g., by main fuel plug 122 closing as described below), the light spring may push plunger back up to close off opening 130 and inhibit dripping of fuel when not under pressure (e.g., when fuel valve 100 is removed from the fuel tank).

Mesh screen 126 may surround opening 130. Mesh screen 126 may filter the fuel as it enters the fuel tank (e.g., to remove particulate in the fuel) and may inhibit contamination of the fuel tank. In some embodiments, valve system 116 includes one or more additional mesh screens 126′ along its length. The additional mesh screens may filter the fuel before it reaches mesh screen 126 and opening 130.

As fuel is flowing through fuel valve 100 and fuel chamber 108, main fuel plug 122 may be in the open position, as shown in FIG. 1. As fuel fills the fuel tank, the level of fuel rises in the fuel tank. When the fuel level reaches primary float 118, the float may begin to rise with the fuel level until the float closes. Primary float 118 may close when a capacity of the fuel tank is reached. Primary float 118 may be coupled to one end of pressure tube 128. Thus, when primary float 118 closes, back pressure may be created in pressure tube 128. Main fuel plug 122 may be coupled to another end of pressure tube 128. The back pressure in pressure tube 128 may cause main fuel plug 122 to rise and shut off flow of fuel towards opening 130. Main fuel plug 122 may remain closed and shut off fuel flow into the fuel tank as long as back pressure remains in pressure tube 128. Primary float 118 may not relieve pressure from pressure tube 128 as the primary float falls due to lowering fuel levels in the fuel tank.

Secondary float 120 may release pressure in pressure tube 128 as the fuel level in the fuel tank drops below a certain level. Secondary float 120 may be coupled to mechanical seal 132 located at a bottom of pressure tube 128. When fuel is filling the fuel tank and the level rises in the fuel tank, secondary float 120 may close mechanical seal 132 on pressure tube 128 before primary float 118 closes. Closing mechanical seal 132 may create back pressure in pressure tube 128 to shutoff the fuel flow in fuel valve 100 (e.g., secondary float 120 may close the mechanical seal at a fuel level slightly below when primary float 118 closes off fuel flow).

As the fuel level in the fuel tank falls with use of the fuel, secondary float 120 may fall with the fuel level in the fuel tank. When secondary float 120 falls below a certain level, the secondary float may cause mechanical seal 132 to open and release pressure (e.g., the back pressure) from pressure tube 128. Release of the pressure in pressure tube 128 may cause main fuel plug 122 to fall (as shown in FIG. 1) and to open the flow of fuel through fuel valve 100.

In certain embodiments, primary float 118 and secondary float 120 operate together to open and close fuel flow into the fuel tank automatically. For example, primary float 118 may close off fuel flow into the tank automatically when the fuel level in the tank reaches a first selected level (e.g., a full capacity of the tank) while secondary float 120 may open flow into the tank when the fuel level drops below a second selected level. In certain embodiments, the second selected level is slightly below the first selected level such that the fuel tank is maintained at or near full capacity during use (e.g., the fuel tank is kept almost full while the fracking pump is running). In such embodiments, fuel valve 100 fills the fuel tank in a substantially continuous capacity (e.g., a continuous or a nearly continuous capacity) as the fuel tank is filled (e.g., the second selected level is reached and main fuel plug 122 is opened) soon after any fuel is used by the fracking pump. In some embodiments, the second selected level is set at a lower level desired for refueling to begin (e.g., ¼ full tank or ¼ full tank).

In some embodiments, the operation of fuel valve 100 is monitored and/or assessed using a computer system coupled to the fuel valve. For example, the computer system may monitor levels of primary float 118 and/or secondary float 120. The computer system may also monitor or assess other properties of fuel valve 100. Examples of properties that may be monitored or assessed include, but are not limited to, fuel flow rate through fuel chamber 108, position of main fuel plug 122 and/or plunger 124, pressure in fuel chamber 108, and temperature of fuel valve 100. The computer system may be configured to provide alarms if fail conditions exist in fuel valve 100. In some embodiments, the computer system may operate to shut off fuel to fuel valve 100 (e.g., using a controlled valve between the fuel source and fuel valve 100) if, for example, a spill or overflow condition is detected.

In certain embodiments of fracking pump systems, each fracking pump has multiple fuel tanks providing fuel to the fracking pump (e.g., 4 fuel tanks may be used with a fracking pump). In such embodiments, one of the fuel tanks (e.g., a primary fuel tank) includes suction for providing fuel to the fracking pump and return from the fracking pump. The remaining fuel tanks may be connected to the primary fuel tank to provide additional fuel when the primary tank runs out of fuel. In certain embodiments, fuel valve 100 is coupled to the primary tank and the remaining tanks are used to provide reserve fuel in case the fuel valve malfunctions, needs maintenance, and/or needs replacement.

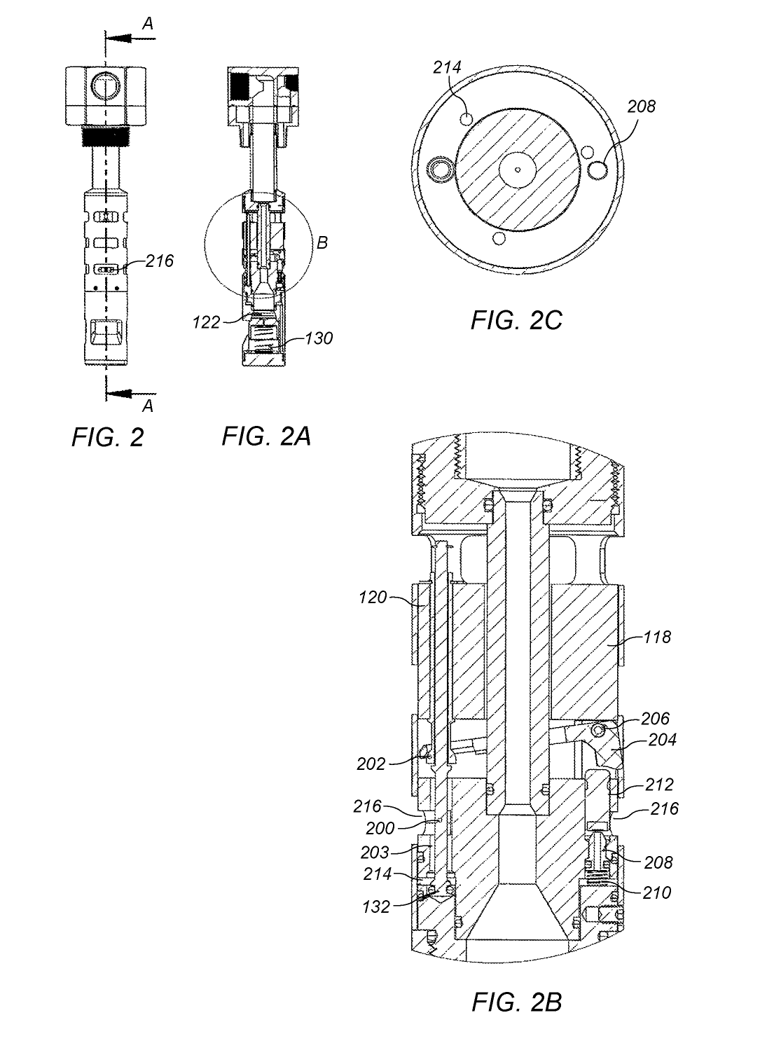

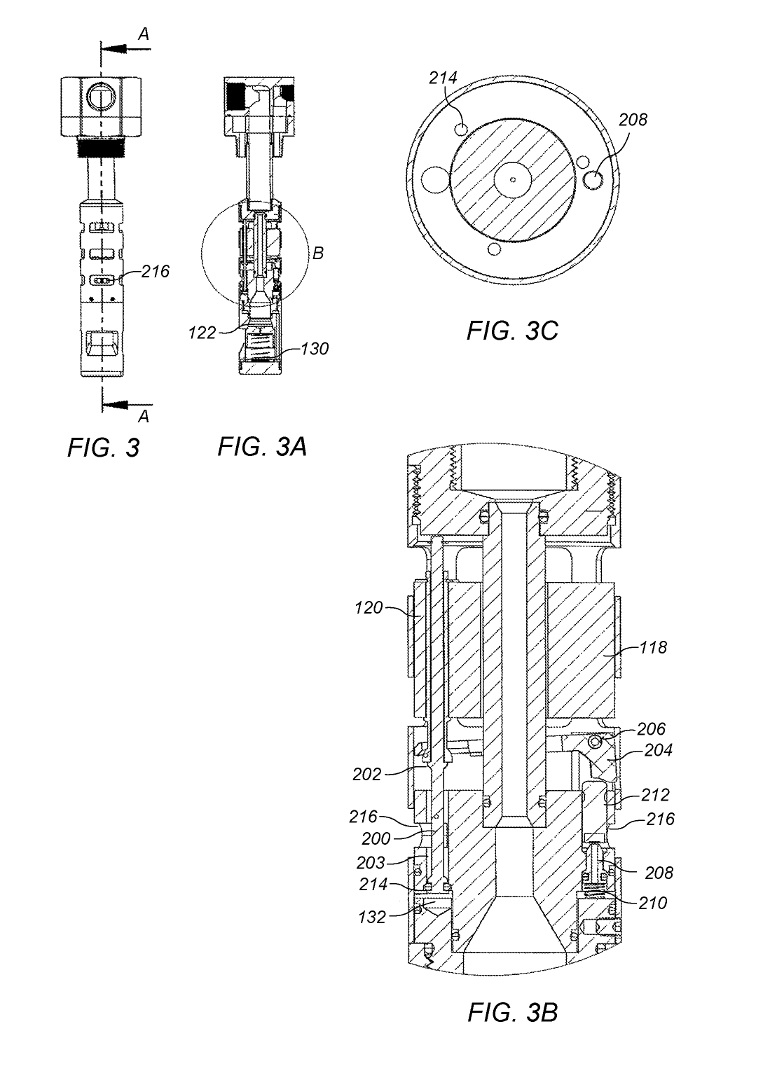

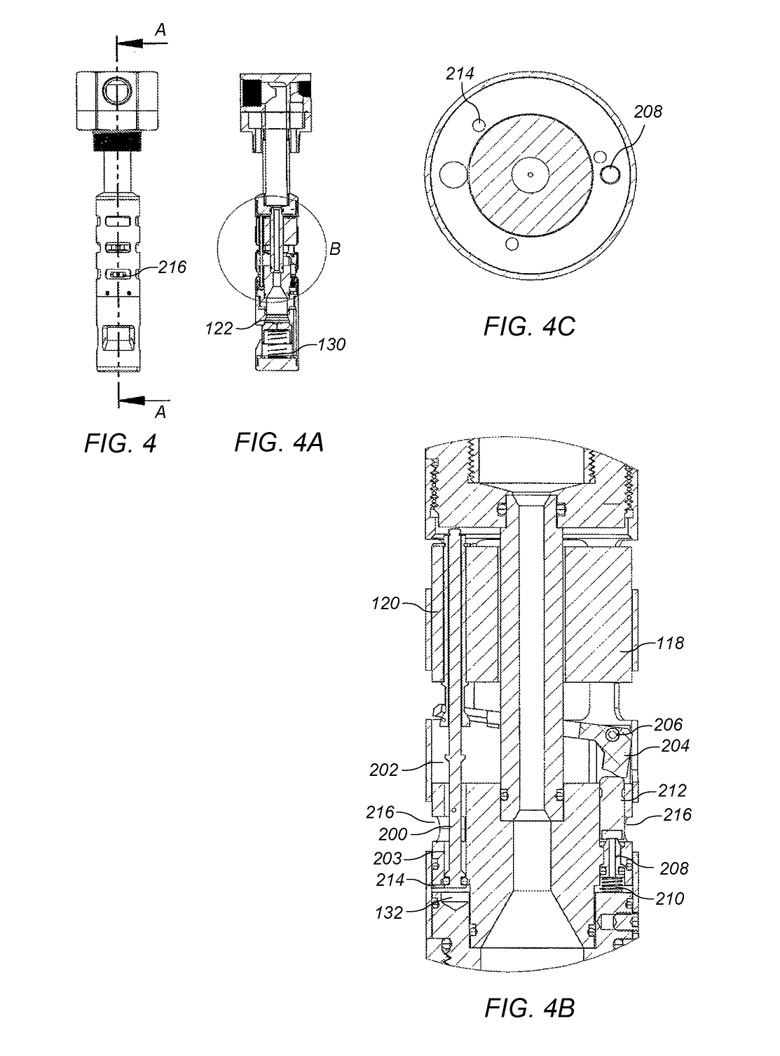

FIGS. 2, 3, and 4 depict side-view representations of an embodiment of fuel valve 100′. FIGS. 2A, 3A, and 4A depict cross-sectional side-view representations of the embodiment of fuel valve 100′. FIGS. 2B, 3B, and 4B depict enlarged cross-sectional side-view representations of embodiments of a portion B (circled in FIGS. 2A, 3A, and 4A) of fuel valve 100′. FIGS. 2C, 3C, and 4C depict cross-sectional top view representations of embodiments of fuel valve 100′. FIGS. 2, 2A, 2B, and 2C depict fuel valve 100′ in an open position (e.g., fuel flowing through the fuel valve). FIGS. 3, 3A, 3B, and 3C depict fuel valve 100′ in a half-closed position (e.g., the secondary float closes the mechanical seal in the fuel valve as the fuel level begins to rise). FIGS. 4, 4A, 4B, and 4C depict fuel valve 100′ in a closed position (e.g., fuel is stopped from flowing through the fuel valve).

In certain embodiments, as shown in FIG. 2B, secondary bleed post 200 is located in fluid passage 203. Fluid passage 203 may allow fluid flow around post 200. Post 200 may be coupled to secondary float 120. Mechanical sleeve 132 may be coupled to an end of post 200 near the bottom of fluid passage 203. In certain embodiments, post 200 is enclosed in secondary bleed post sleeve 202. Sleeve 202 may be coupled to lever 204. Lever 204 may rotate about hinge point 206.

In certain embodiments, fuel valve 100′ includes bleed pin 208 coupled to bleed pin spring 210. Bleed pin 208 may include a port through the pin to allow fluid flow through the pin. Valve 212 may be positioned above bleed pin 208. Openings 216 may allow fluid to flow in/out of fluid passage 203 around post 200 and in/out around bleed pin 208. Fluid passages 214, shown in FIGS. 2B and 2C, may be fluidly coupled to openings 216, fluid passage 203, bleed pin 208, and main fuel plug 122. In some embodiments, a pressure tube couples fluid passages 214 to main fuel plug 122.

As shown in FIG. 2B, when fuel valve 100′ is in the open position, fluid flows between fuel passages 214, fluid passage 203, and bleed pin 218. Thus, pressure is equalized at main fuel plug 122 and fuel valve 100′ remains open. As fuel fills the fuel tank, the level of fuel rises in the fuel tank and primary float 118 and secondary float 120 may begin to rise. As shown in FIG. 3B, when secondary float 120 rises to a selected fuel level, post 200 may rise and thus, mechanical seal 132 (attached to the end of the post) may rise and close the bottom of fluid passage 203 (e.g., the mechanical seal provides a seal at the bottom of the fluid passage). Fluid flow between fluid passage 203 and fluid passages 214 may be inhibited when mechanical seal 132 closes the bottom of fluid passage 203. Fluid flow may remain, however, through bleed pin 208 and between the bleed pin and fluid passages 214.

In certain embodiments, as primary float 118 rises to a selected fluid level (e.g., when a capacity of the fuel tank is reached), sleeve 202 rises and rotates lever 204. As lever 204 rotates, the lever may contact valve 212 and push the valve down towards bleed pin 208 until the valve inhibits flow through the bleed pin, as shown in FIG. 4B. Inhibiting flow through bleed pin 208, with flow from fluid passage 203 already closed off by mechanical seal 132, may create back pressure in fluid passages 214 and cause main fuel plug 122 to rise and shut off flow of fuel towards opening 130. Main fuel plug 122 may remain closed as long as back pressure remains in fluid passages 214 (e.g., as long as flow through bleed pin 208 is inhibited and fluid flow to/from fluid passage 203 is closed off).

As the fuel level in the fuel tank falls with use of the fuel, primary float 118 and secondary float 120 may fall with the fuel level in the fuel tank. Falling of primary float 118 and uninhibiting fluid flow through bleed pin 208, however, may not relieve back pressure in fluid passages 214 and the pressure tube. In certain embodiments, back pressure in fluid passages 214 and the pressure tube is relieved when secondary float 120 falls below a selected level. When secondary float 120 falls below the selected level, the secondary float may cause mechanical seal 132 to open and release pressure (e.g., the back pressure) from fluid passages 214. Release of the pressure in fluid passages 214 may release the pressure in the pressure tube and cause main fuel plug 122 to fall and open the flow of fuel through fuel valve 100′, as shown in FIG. 2B.

In certain embodiments, fuel valve 100′ operates to automatically open and close fuel flow into the fuel tank. For example, primary float 118 may close off fuel flow into the tank automatically when the fuel level in the tank reaches a first selected level (e.g., a full capacity of the tank) while secondary float 120 may open flow into the tank when the fuel level drops below a second selected level. In certain embodiments, the second selected level is slightly below the first selected level such that the fuel tank is maintained at or near full capacity during use (e.g., the fuel tank is kept almost full while the fracking pump is running). In such embodiments, fuel valve 100′ fills the fuel tank in a substantially continuous capacity (e.g., a continuous or a nearly continuous capacity) as the fuel tank is filled (e.g., the second selected level is reached and main fuel plug 122 is opened) soon after any fuel is used by the fracking pump. In some embodiments, the second selected level is set at a lower level desired for refueling to begin (e.g., ½ full tank or ¾ full tank).

In some embodiments, the operation of fuel valve 100′ is monitored and/or assessed using a computer system coupled to the fuel valve. For example, the computer system may monitor levels of primary float 118 and/or secondary float 120. The computer system may also monitor or assess other properties of fuel valve 100′. Examples of properties that may be monitored or assessed include, but are not limited to, fuel flow rate through fuel passages 214, position of main fuel plug 122, post 200, and/or lever 204, pressure in fluid passage 203, and temperature of fuel valve 100′. The computer system may be configured to provide alarms if fail conditions exist in fuel valve 100′. In some embodiments, the computer system may operate to shut off fuel to fuel valve 100′ (e.g., using a controlled valve between the fuel source and fuel valve 100′) if, for example, a spill or overflow condition is detected.

In certain embodiments of fracking pump systems, each fracking pump has multiple fuel tanks providing fuel to the fracking pump (e.g., 4 fuel tanks may be used with a fracking pump). In such embodiments, one of the fuel tanks (e.g., a primary fuel tank) includes suction for providing fuel to the fracking pump and return from the fracking pump. The remaining fuel tanks may be connected to the primary fuel tank to provide additional fuel when the primary tank runs out of fuel. In certain embodiments, fuel valve 100′ is coupled to the primary tank and the remaining tanks are used to provide reserve fuel in case the fuel valve malfunctions, needs maintenance, and/or needs replacement.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a valve” includes a combination of two or more valves and reference to “a fluid” includes mixtures of fluids.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

What is claimed is:

1. An automatic filling device for a fuel tank coupled to a fracking pump, comprising:
a valve body configured to be coupled to a fuel cap connection on the fuel tank;
a fuel supply port on an upper portion of the valve body;
a fuel discharge opening on a lower portion of the valve body;
a fuel chamber in the valve body connecting the fuel supply port and the fuel discharge opening to allow fuel to flow between the fuel supply port and the fuel discharge opening, wherein, when the valve body is coupled to the fuel tank, the fuel supply port is located outside the fuel tank and the fuel discharge opening is located inside the fuel tank;
a main fuel plug located on the fuel chamber above the fuel discharge opening, wherein, when open, the main fuel plug allows fuel to flow in the fuel chamber towards the fuel discharge opening and, when closed, the main fuel plug inhibits fuel to flow towards the fuel discharge opening;
a primary float located on the fuel chamber above the main fuel plug, wherein the primary float closes when a first selected fuel level is reached in the fuel tank;
a pressure tube coupled between the main fuel plug and the primary float, wherein, when the primary float closes, the pressure tube is filled with back pressure and causes the main fuel plug to close; and
a secondary float located on the fuel chamber above the main fuel plug, wherein the secondary float operates a mechanical seal located at a bottom of the pressure tube, and wherein the secondary float closes the mechanical seal when the secondary float is above the first selected fuel level and the secondary float opens the mechanical seal when the secondary float is below a second selected fuel level.

2. The device of claim 1, wherein the secondary float is positioned to reach the first selected fuel level before the primary float when the fuel tank is being filled with fuel such that the secondary float closes the mechanical seal before the primary float closes.

3. The device of claim 1, further comprising a plunger located at the fuel discharge opening, wherein the plunger opens under pressure when fuel flows towards the opening and closes when fuel flow towards the opening is stopped and pressure on the plunger is relieved.

4. The device of claim 1, further comprising a mesh screen positioned at the fuel discharge opening.

5. The device of claim 1, further comprising a vent port located outside the fuel tank when the valve body is coupled to the fuel tank, wherein the vent line is coupled to a vent line that opens to the fuel tank when the valve body is coupled to the fuel tank, and wherein the vent line and the vent port release pressure from the fuel tank while filling the fuel tank.

6. The device of claim 1, wherein the first selected fuel level comprises a fill capacity of the fuel tank.

7. The device of claim 1, wherein the second selected fuel level is less than the first selected fuel level.

8. The device of claim 1, wherein the second selected fuel level is at least about ¼ a capacity of the fuel tank.

9. A system for filling a fuel tank coupled to a fracking pump, comprising:
a device configured to automatically open and close fuel flow to a fuel tank coupled to a fracking pump, wherein the device automatically opens and closes fuel flow to the fuel tank based on a level of fuel in the fuel tank, the device comprising:
a valve body configured to be coupled to a fuel cap connection on the fuel tank;
a fuel supply port on an upper portion of the valve body;
a fuel discharge opening on a lower portion of the valve body;
a fuel chamber in the valve body connecting the fuel supply port and the fuel discharge opening to allow fuel to flow between the fuel supply port and the fuel discharge opening, wherein, when the valve body is coupled to the fuel tank, the fuel supply port is located outside the fuel tank and the fuel discharge opening is located inside the fuel tank;
a main fuel plug located on the fuel chamber above the fuel discharge opening, wherein, when open, the main fuel plug allows fuel to flow in the fuel chamber towards the fuel discharge opening and, when closed, the main fuel plug inhibits fuel to flow towards the fuel discharge opening;
a primary float located on the fuel chamber above the main fuel plug, wherein the primary float closes when a first selected fuel level is reached in the fuel tank;
a pressure tube coupled between the main fuel plug and the primary float, wherein, when the primary float closes, the pressure tube is filled with back pressure and causes the main fuel plug to close; and
a secondary float located on the fuel chamber above the main fuel plug, wherein the secondary float operates a mechanical seal located at a bottom of the pressure tube, and wherein the secondary float closes the mechanical seal when the secondary float is above the first selected fuel level and the secondary float opens the mechanical seal when the secondary float is below a second selected fuel level.

10. The system of claim 9, wherein the secondary float is positioned to reach the first selected fuel level before the primary float when the fuel tank is being filled with fuel such that the secondary float closes the mechanical seal before the primary float closes.

11. The system of claim 9, wherein the device further comprises a plunger located at the fuel discharge opening, and wherein the plunger opens under pressure when fuel flows towards the opening and closes when fuel flow towards the opening is stopped and pressure on the plunger is relieved.

12. The system of claim 9, wherein the device further comprises a mesh screen positioned at the fuel discharge opening.

13. The system of claim 9, wherein the device further comprises a vent port located outside the fuel tank when the valve body is coupled to the fuel tank, wherein the vent line is coupled to a vent line that opens to the fuel tank when the valve body is coupled to the fuel tank, and wherein the vent line and the vent port release pressure from the fuel tank while filling the fuel tank.

14. The system of claim 9, wherein the first selected fuel level comprises a fill capacity of the fuel tank.

15. The system of claim 9, wherein the second selected fuel level is less than the first selected fuel level.

16. The system of claim 9, wherein the device is configured to automatically open and close fuel flow to the fuel tank while the fracking pump is in operation.

17. A method for filling a fuel tank coupled to a fracking pump, comprising:
providing fuel from a fuel source to a fuel tank coupled to a fracking pump, wherein a flow of the fuel into the fuel tank is automatically controlled by a device coupled to a fuel cap connection on the fuel tank, and wherein the device automatically opens and closes the flow of fuel to the fuel tank based on a level of fuel in the fuel tank, the device comprising:
a valve body coupled to the fuel cap connection on the fuel tank;
a fuel supply port on an upper portion of the valve body;
a fuel discharge opening on a lower portion of the valve body;
a fuel chamber in the valve body connecting the fuel supply port and the fuel discharge opening to allow fuel to flow between the fuel supply port and the fuel discharge opening, wherein the fuel supply port is located outside the fuel tank and the fuel discharge opening is located inside the fuel tank;
a main fuel plug located on the fuel chamber above the fuel discharge opening, wherein, when open, the main fuel plug allows fuel to flow in the fuel chamber towards the fuel discharge opening and, when closed, the main fuel plug inhibits fuel to flow towards the fuel discharge opening;
a primary float located on the fuel chamber above the main fuel plug, wherein the primary float closes when a first selected fuel level is reached in the fuel tank;
a pressure tube coupled between the main fuel plug and the primary float, wherein, when the primary float closes, the pressure tube is filled with back pressure and causes the main fuel plug to close; and
a secondary float located on the fuel chamber above the main fuel plug, wherein the secondary float operates a mechanical seal located at a bottom of the pressure tube, and wherein the secondary float closes the mechanical seal when the secondary float is above the first selected fuel level and the secondary float opens the mechanical seal when the secondary float is below a second selected fuel level.

18. The method of claim 17, wherein the secondary float is positioned to reach the first selected fuel level before the primary float when the fuel tank is being filled with fuel such that the secondary float closes the mechanical seal before the primary float closes.

19. The method of claim 17, wherein the fuel is provided from the fuel source to the fuel tank while the fracking pump is in operation.

20. The method of claim 17, further comprising assessing, using a computer system, if one or more fail conditions exist in the device, wherein the computer system operates to shut off fuel to the device using a computer controlled valve between the fuel source and the device when at least one of the fail conditions exists in the device.
